(19) United States
(12) Patent Application Publication
(10) Pub. No.: US 2015/0250567 A1
(43) Pub. Date: Sep. 10, 2015

(54) Orthodontic anchor screw device

(71) Applicants: Darren E. Buddemeyer, Frontenac, MO (US); Ki Beom Kim, Clayton, MO (US)

(72) Inventors: Darren E. Buddemeyer, Frontenac, MO (US); Ki Beom Kim, Clayton, MO (US)

(21) Appl. No.: 14/544,916

(22) Filed: Mar. 6, 2015

Related U.S. Application Data
(60) Provisional application No. 61/967,153, filed on Mar. 10, 2014.

(51) Int. Cl. A61C 8/00

(52) U.S. Cl. CPC A61C 8/0096; A61C 8/0025

(57) ABSTRACT

An orthodontic anchor screw device is disclosed in which the device comprises a threaded barrel section, a first transition area having an alignment marking, a second transition area, and a screw head.

### CROSS REFERENCE TO RELATED APPLICATION

This non-provisional patent application claims priority to the provisional patent application having Ser. No. 61/967,153, filed on Mar. 10, 2014.

### FIELD OF THE DISCLOSURE

This disclosure generally relates to orthodontic devices for assisting in orthodontic treatments or procedures, and more particularly to an orthodontic anchor screw device for use in orthodontic correction treatments or procedures.

### BACKGROUND

Orthodontists treat patients by controlling the movement and displacement of teeth in a mouth by use of various orthodontic devices and procedures. Movement or rotation of a tooth within the mouth may be accomplished through the use of external forces applied to the tooth. To ensure that the moved or treated tooth remains in a desired location in the jaw bone, an external force is applied to the tooth for an extended period of time. Once the tooth has reached a desired position or orientation, the force may be removed. Some examples of devices used to apply the necessary force to the tooth are wires, clamps, or rubber bands.

Orthodontic anchoring screws are also used in orthodontic procedures. An orthodontic anchoring screw is temporarily inserted into the jaw bone and removed from the jaw bone once the procedure is successful. A wire or other device may be connected to the screw and then attached to another device positioned on a tooth. In this manner, torque or force may be applied to the tooth to reposition the tooth to a desired orientation. In some procedures more than one orthodontic anchoring screw may be used or required. Although orthodontic anchoring screws are useful, there is no way to align one orthodontic anchoring screw relative to another.

The present disclosure is designed to obviate and overcome many of the disadvantages and shortcomings experienced with prior orthodontic anchoring screws. Moreover, the present disclosure is related to an orthodontic anchor screw device that can be aligned relative to another orthodontic anchoring screw device.

An example of anchor screws for use for orthodontic treatments can be seen in the U.S. Pat. No. 6,669,473, to Maino. Other patents showing related technology can be seen in U.S. Pat. Nos. 8,113,826, 7,500,851, 7,094,051, 6,877,982, 6,719,557, 6,520,772, 6,402,510, 6,241,517, 6,036,488, 5,919,042, 5,769,631, and 5,645,422. These are examples of orthodontic devices that may incorporate screws.

### SUMMARY OF THE DISCLOSURE

The present disclosure is an orthodontic anchor screw device which comprises a threaded barrel section, a first transition area having an alignment marking, a second transition area, and a screw head. The present disclosure is also directed to an orthodontic anchor screw device which comprises a threaded barrel section, a first transition area having a number of alignment markings spaced along the first transition area, a second transition area, and a screw head. In another embodiment, an orthodontic anchor screw device comprises a threaded barrel section, a first sloped transition area, a second transition area having a number of alignment markings spaced along the second transition area, a third transition area, and a screw head.

In light of the foregoing comments, it will be recognized that the present disclosure provides an orthodontic anchor screw device for use in orthodontic procedures.

The present disclosure provides an orthodontic anchor screw device that can be easily employed with highly reliable results to be inserted into a jaw bone and have a device connected to the screw device to exert a force on a tooth to treat the tooth.

The present disclosure also provides an orthodontic anchor screw device that may be used to be inserted into a jaw bone to be aligned with another orthodontic anchor screw device.

The present disclosure further provides an orthodontic anchor screw device that may be temporarily screwed into a jaw bone and counteract any rotational movement that would loosen the screw device. The current disclosure provides an orthodontic anchor screw device that may also cooperate with other orthodontic appliances, when applied, to provide for remedying teeth on alignment or for other teeth corrective purposes when applied for the treatment of the teeth within a patient's mouth.

The present disclosure provides an orthodontic anchor screw device that requires only a few tools or hand applied dental appliances, for inserting or removing the screw device from a jaw bone.

The present disclosure provides an orthodontic anchor screw device that has coarse threads and fine threads for locking the screw device into a jaw bone to inhibit rotation of the screw device once screwed into a bone and a force is applied to the screw device.

These and other advantages of the present disclosure will become apparent to those skilled in the art after considering the following detailed specification in conjunction with the accompanying drawings.

### BRIEF DESCRIPTION OF THE DRAWINGS

In referring to the drawings:

FIG. 1 is a perspective side view of an orthodontic anchor screw device constructed according to the present disclosure;

FIG. 2 is a top view of the orthodontic anchor screw device constructed according to the present disclosure;

FIG. 3 is an enlarged partial view of a screw portion of the orthodontic anchor screw device shown in FIG. 1 taken within the circle A shown in FIG. 1;

FIG. 4 is an enlarged partial view of another screw portion of the orthodontic anchor screw device shown in FIG. 1 taken within the circle B shown in FIG. 1;

FIG. 5 is an enlarged partial view of another screw portion of the orthodontic anchor screw device shown in FIG. 1 taken within the circle C shown in FIG. 1; and

FIG. 6 is an enlarged partial side view of a top portion of the orthodontic anchoring screw device constructed according to the present disclosure.

### DETAILED DESCRIPTION OF PREFERRED EMBODIMENTS

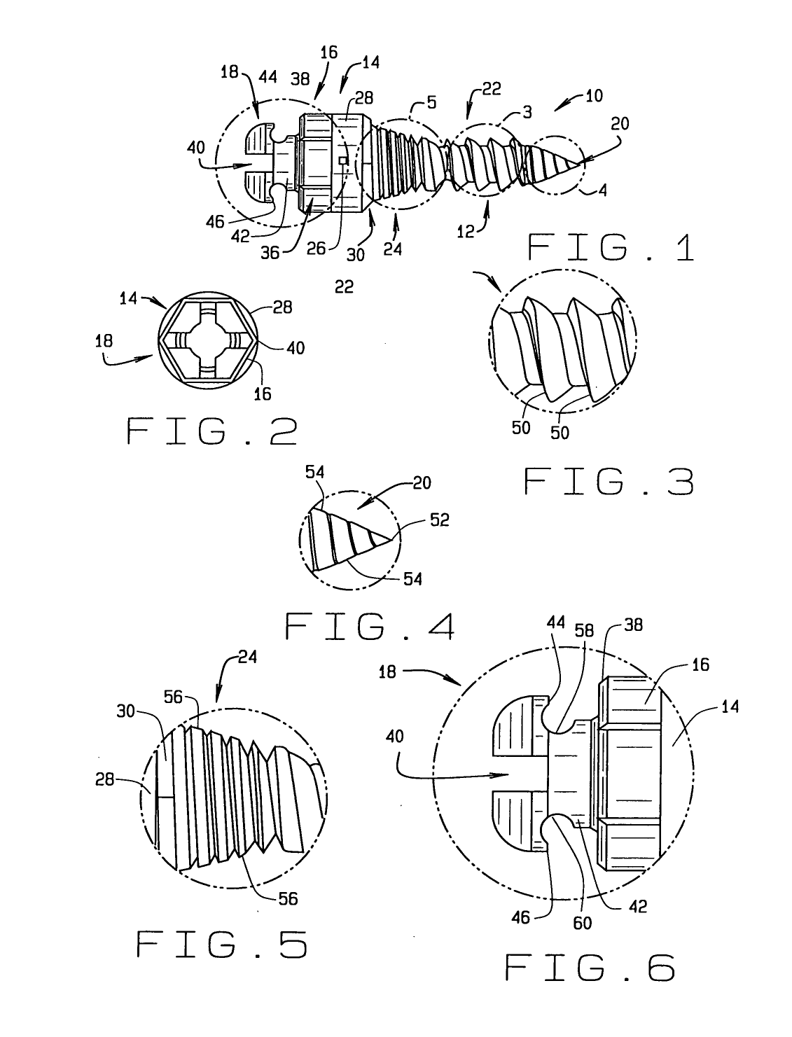

Referring now to the drawings, wherein like numbers refer to like items, number 10 identifies a preferred embodiment of an orthodontic anchor screw device constructed according to the present disclosure. With reference now to FIG. 1, the orthodontic anchor screw device 10 comprises a threaded barrel like section 12, a first transition area 14, a second transition area 16, and a screw head 18. The threaded barrel section 12 has a cutting end 20, a coarsely threaded section 22, and a finely threaded section 24. The cutting point 20 is for cutting through a gum of an individual and into a jaw bone for anchoring the device 10. The first transition area 14 has an alignment marking 26 placed on a side 28 of the first transition area 14. The alignment marking 26 is used to align one of the devices 10 relative to another device 10 to perform an orthodontic installation procedure. A sloped or chamfer transition area 30 is positioned between the threaded barrel section 12 and the first transition area 14. The sloped transition area 30 provides a smooth transition of the device 10 when the device 10 intersects a gum line of an individual. The finely threaded section 24 is sloped outwardly from the coarsely threaded section 22 toward the transition area 30.

The first transition area 14 is circular in shape and has other alignment markings 26 placed on the side 28 around the area 14. For example, the alignment markings 26 may be placed equidistant from each other such as 90° apart from each other around the area 14. Any number of alignment markings 26 are possible and contemplated that may be placed on the side 28. Again, by way of example only, if three alignment markings 26 are used then the markings 26 may be evenly or equally spaced about the side 28 of the first transition area 14 at 120° intervals.

The second transition area 16 has a side 36 that has a generally hexagonal shape. The first transition area 14 has a diameter and the second transition area 16 has a diameter. The diameter of the first transition area 14 is greater than the diameter of the second transition area 16. Also, the diameter of the first transition area 14 is greater than the threaded barrel 12 and the screw head 18. Another chamfer or sloped section 38 is formed between the second transition area 16 and the screw head 18.

The screw head 18 has a first slot 40 formed therein. The first slot 40 is used to capture and hold a wire (not shown) that is used in an orthodontic procedure. The screw head 18 is connected to the second transition area 16 by a neck portion 42. A first overhang portion 44 and a second overhang portion 46 each extend downwardly from the screw head 18.

FIG. 2 shows a top view of the orthodontic anchor screw device 10 which is a view of the screw head 18. The screw head 18 is designed having the hexagonal or related contour or shaped side 36 that allows a similarly shaped tool or socket (not shown) to be placed thereon to assist in screwing the device 10 into a jaw bone or unscrewing the device 10 from a jaw bone. The hexagonal shape 36 also allows the screw device 10 to be adjusted in small increments to align the alignment markings 26 of one device 10 with alignment markings 26 of another or adjacent screw device 10. The first slot 40 is shown being perpendicular to a second slot 48 formed in the screw head 18. The slots 40 and 48 are provided for receiving fastening or adjusting elements or devices (not shown) such as wires, posts, springs, or rubber bands which are applied in orthodontic treatments or procedures. It is also possible that the crossed slots 40 and 48 may be used to receive a screw driver or other tool. The side 28 of the first transition area 14 is shown having a larger diameter than the diameter of the second transition area 16. Also, since the first transition area 14 has a larger diameter than the diameter of the threaded barrel 12, the threaded barrel 12 is not totally visible in this view. Further, although not shown in this particular drawing, it is possible to align each of the markings 26 with the slots 40 and 48.

Referring now to FIG. 3, an enlarged partial view of the coarsely threaded section 22 of the orthodontic anchor screw device 10 is shown. The coarsely threaded section 22 has a number of threads 50 that are spaced apart from each other. The threads 50 facilitate the insertion of the device 10 into a jaw bone and also assist in holding the device 10 in a jaw bone once inserted. The threads 50 may have a pitch of 0.7 mm., more or less. The threads 50 are used to cut into gum and bone when the device 10 is screwed into a jaw.

FIG. 4 shows an enlarged partial view of the cutting end 20 that is used to cut into gum and bone. The cutting end 20 has a sharp point 52 and a number of threads 54. The threads 54 are approximately 60° V-thread double lead type threads. The threads 54 are used to coarsely cut into bone when the device 10 is screwed into a jaw.

FIG. 5 illustrates an enlarged partial view of the finely threaded section 24 of the orthodontic anchor screw device 10. The finely threaded section 24 has a number of threads 56 that are spaced apart from each other. The threads 56 are spaced closer to each other than the threads 50 of the coarsely threaded section 22. By way of example only, the number of threads 56 may be double the number of threads 50. A human jaw has a relatively hard upper layer called the compacta and a relatively softer layer called the spongiosa. The finely threaded section 24 secures the device 10 within the compacta. The threads 56 are about 60° V-thread double lead type threads. The sloped transition area 30, which provides a smooth transition between the finely threaded section 24 and the side 28, is also shown in this view and is used when the device 10 intersects a gum line of an individual.

With reference now to FIG. 6, an enlarged partial side view of the screw head 18 of the orthodontic anchoring screw device 10 constructed according to the present disclosure is illustrated. The screw device 10 is shown comprising the screw head 18 having the slot 40. The screw head 18 has the first overhang portion 44 and the second overhang portion 46. The screw head 18 is connected to the neck portion 42. The neck portion 42 is connected to the hexagonal shaped second transition area 16. The second transition area 16 is adjacent to the first transition area 14. The sloped transition area 38 is also shown being formed between the second transition area 16 and the neck 42. A first rounded area or groove 58 is formed between the neck 42 and the first overhang portion 44. A second rounded area or groove 60 is formed between the neck 42 and the second overhand portion 46. The rounded areas 58 and 60 are used to capture and hold a wire or a spring in place.

During treatment, the orthodontic anchor screw device 10 is screwed into a gum and a jaw bone to temporarily secure the device 10 into a jaw bone. A tool socket (not shown) having a hexagonal shape is placed over the hexagonal contour 36 of the second transition area 16 to drive the device 10 into a jaw bone. The cutting point 52 assists in positioning the device 10 against a gum and to drive the device 10 into a jaw bone. Once the device 10 is anchored into a jaw bone, a tooth may be treated by attaching one end of a wire to the slots 40 and 48 or the rounded areas 58 and 60 formed in the screw head 18 and another end of the wire to a device attached to the tooth. In this manner, the wire can be tightened to force the tooth into a desired position or orientation. The alignment marking 26 may be used to align the screw device 10 with another screw device 10. Once the treatment has been completed, the wire may be removed from the screw head 18 and the device 10 may be removed from the jaw bone by unscrewing the device 10. For example, the socket may be positioned on the contour 36 of the screw head 18 to remove or unscrew the device 10 from a jaw bone.

From all that has been said, it will be clear that there has thus been shown and described herein an orthodontic anchor screw device. It will become apparent to those skilled in the art, however, that many changes, modifications, variations, and other uses and applications of the subject orthodontic anchor screw device are possible and contemplated. All changes, modifications, variations, and other uses and applications which do not depart from the spirit and scope of the disclosure are deemed to be covered by the disclosure, which is limited only by the claims which follow.

While previously reviewed, the Anchor Screw Device may have one or more slots formed within its head, as previously reviewed at 40, and these head slots may be to various dimensions, such as a 4.5 mm., 6 mm., 8 mm., or other dimensions, for the slot head screw of this disclosure.

We claim:

1. An orthodontic anchor screw device comprising:
a threaded barrel section;
a first transition area;
a second transition area; and
a screw head.

2. The orthodontic anchor screw device of claim 1 wherein the threaded barrel section comprises a cutting point, a coarsely threaded section, and a finely threaded section.

3. The orthodontic anchor screw device of claim 1 wherein the first transition area has a diameter and the threaded barrel section has a diameter and the diameter of the first transition area is greater than the diameter of the threaded barrel section.

4. The orthodontic anchor screw device of claim 1 wherein the first transition area further includes an alignment marking.

5. The orthodontic anchor screw device of claim 1 wherein the first transition area has a diameter and the second transition area has a diameter and the diameter of the first transition area is greater than the diameter of the second transition area.

6. The orthodontic anchor screw device of claim 1 wherein the screw head comprises a hex head for receiving a hex driver for screwing or unscrewing the orthodontic anchor screw device.

7. The orthodontic anchor screw device of claim 1 wherein the screw head comprises a groove for receiving a wire.

8. An orthodontic anchor screw device comprising:
a threaded barrel section;
a first transition area having a number of alignment markings spaced along the first transition area;
a second transition area; and
a screw head.

9. The orthodontic anchor screw device of claim 8 wherein the threaded barrel section comprises a cutting point, a coarsely threaded section, and a finely threaded section.

10. The orthodontic anchor screw device of claim 8 wherein the first transition area has a diameter and the threaded barrel section has a diameter and the diameter of the first transition area is greater than the diameter of the threaded barrel section.

11. The orthodontic anchor screw device of claim 8 wherein the first transition area has a diameter and the second transition area has a diameter and the diameter of the first transition area is greater than the diameter of the second transition area.

12. The orthodontic anchor screw device of claim 8 wherein the screw head comprises a hex head for receiving a hex driver for screwing or unscrewing the orthodontic anchor screw device.

13. The orthodontic anchor screw device of claim 8 wherein the screw head comprises a groove for receiving a wire.

14. The orthodontic anchor screw device of claim 8 wherein the screw head comprises a first groove and a second groove which is perpendicular to the first groove, the first groove and the second groove for receiving a wire.

15. An orthodontic anchor screw device comprising:
a threaded barrel section;
a first sloped transition area;
a second transition area having a number of alignment markings spaced along the second transition area;
a third transition area; and
a screw head.

16. The orthodontic anchor screw device of claim 15 wherein the threaded barrel section comprises a cutting point, a coarsely threaded section, and a finely threaded section.

17. The orthodontic anchor screw device of claim 15 wherein the second transition area has a diameter and the threaded barrel section has a diameter and the diameter of the second transition area is greater than the diameter of the threaded barrel section.

18. The orthodontic anchor screw device of claim 15 wherein the second transition area has a diameter and the third transition area has a diameter and the diameter of the second transition area is greater than the diameter of the third transition area.

19. The orthodontic anchor screw device of claim 15 wherein the screw head comprises a hex head for receiving a hex driver for screwing or unscrewing the orthodontic anchor screw device.

20. The orthodontic anchor screw device of claim 15 wherein the screw head comprises a groove for receiving a wire.

21. The orthodontic anchor screw device of claim 1 wherein said first transition area includes at least one alignment marking.

22. The orthodontic anchor screw device comprising:
a threaded barrel section having a cutting point, a coarsely threaded section, and a finely threaded section, said screw device having at least one transition area, and a screw head, wherein an orthodontic tool may be applied for screwing or unscrewing the orthodontic anchor screw device relative to the patient's jaw bone.
